(19) United States
(12) Patent Application Publication
(10) Pub. No.: US 2004/0093612 A1
(43) Pub. Date: May 13, 2004

(54) Auto-balancing device for the motor of a CD-ROM player

(75) Inventor: Ying-Chun Chang, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/703,597

(22) Filed: Nov. 10, 2003

(30) Foreign Application Priority Data
Aug. 30, 2002 (TW) 91213673

(51) Int. Cl. F16F 15/22; G11B 19/20

(52) U.S. Cl. 720/702; 74/573 R

(57) ABSTRACT

An auto-balancing device mounted on the spindle of the motor of a disk player is disclosed to include a device shell, which defines an inner annular track and an outer annular track concentrically arranged around the center hub thereof, a plurality of rolling balls movably received in the inner annular track, and a balancing fluid filled in the outer annular track and worked with the rolling balls to produce a balancing force during rotary motion of the motor of the disk player, and to further balance eccentricity of mass and prohibit the production of vibrations and noises.

### BACKGROUND OF THE INVENTION

1. Field of the Invention

The present invention relates to an auto-balancing device and, more particularly, to a complex type auto-balancing device suitable for use in a motor of a disk player such as CD-ROM player, CD player, DVD player, DVD-ROM player, hard disk, and etc.

2. Description of Related Art

Regular personal computers, home video players, or automobile stereo systems are commonly equipped with a CD-ROM player. Following the improvement of CD-ROM player's reading speed, the revolving speed of the motor must be relatively improved. However, when increasing the revolving speed of the motor, the eccentricity of mass of the disk or the motor's rotor causes vibrations, which are transmitted to the access positioning system, read head, and suspension system via the motor bearing, thereby causing a friction loss between the motor spindle and the motor bearing and a wearing between the gears and screw rods of the positioning system. A friction loss between the motor spindle and the motor bearing or a wearing between the gears and screw rods of the positioning system may result in data access failure of the access system, or damage to the system.

Further, to the focusing of a programmer during copying, the data accessing of a high-density DVD, or the high-speed running of a hard disk driver, the problem of vibration is critical. Therefore, how to keep the disk and the motor in balance, how to minimize vibration damage to the CD-ROM player, and how to maintain transmission and writing in stability during a high speed rotation of the motor are the key techniques in the design of CD-ROM players.

Referring to FIG. 3, many manufacturers installed a rolling ball type auto-balancing device in their CD-ROM players to reduce vibration. A rolling ball type auto-balancing device for this purpose is generally comprised of a device shell defining a single annular track 81, and steel balls 811 moving in the annular track 81. However, this design of rolling ball type auto-balancing device is still not satisfactory in function because it cannot eliminate dry friction between the steel balls 811 and the track 81 or the problems of vibrations and noises.

Therefore, it is desirable to provide an auto-balancing device for CD-ROM motor, which eliminates the aforesaid problems.

### SUMMARY OF THE INVENTION

It is the main object of the present invention to provide an auto-balancing device for a motor of a disk player, which prohibits the production of vibrations and noises upon rotation of the motor.

To achieve this and other objects of the present invention, the auto-balancing device is mounted on a spindle of a motor of a disk player. The auto-balancing device is comprised of a device shell, a plurality of rolling balls, and a balancing fluid. The device shell comprises an outer race, a hub, a center axle hole axially extended through the center of the hub and mounted on the spindle of the motor, an open chamber defined around the periphery of the hub within the outer race, an inner race suspended in the open chamber and concentrically arranged between the outer race and the hub, an inner annular track defined around the periphery of the hub within the inner race, and an outer annular track defined around the periphery of the inner race within the outer race. The rolling balls are movably received in the inner annular track. The balancing fluid is filled in the outer annular track. During rotary motion of the motor of the disk player, the balancing force of the combination design of the rolling balls and the balancing fluid balances eccentricity of mass and prohibits the production of vibrations and noises. The balancing fluid is a fluid of high viscosity, for example, oil, cream, glycerin, or lubricant. The invention can also comprise an oil seal, which is fastened to the device shell to seal the balancing fluid in the outer annular track.

Further, the size and weight of the rolling balls and the type and viscosity of the balancing fluid can be determined subject to experimentation to fit different rotation conditions.

### BRIEF DESCRIPTION OF THE DRAWINGS

FIG. 1 is an exploded view of a motor for CD-ROM player constructed according to the present invention.

FIG. 2 illustrates the architecture of the auto-balancing device according to the present invention.

FIG. 3 illustrates the architecture of an auto-balancing device used in a motor for CD-ROM player according to the prior art.

### DETAILED DESCRIPTION OF THE PREFERRED EMBODIMENT

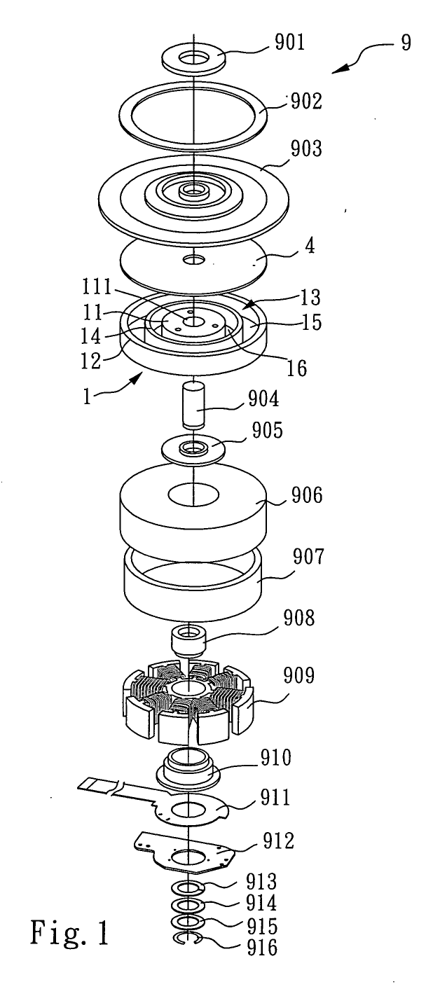

Referring to FIG. 1, a motor 9 for use in a disk player, in this embodiment is a CD-ROM player, is shown comprised of a hub magnet 901, an annular anti-skid plate 902, a turntable 903, an oil seal 4, an auto-balancing device shell 1, a spindle 904, a bearing 905, a magnetically conductive yoke iron 906, a magnet 907, a hydraulic bearing 908, an iron core 909, an axle bush 910, a circuit board 911, a bottom plate 912, a C-shaped clamp 913, a friction plate 914, a gasket ring 915, and a retainer 916. The motor 9 runs rotary action by means of principle of electromagnetism. The auto-balancing device shell 1 is mounted on the spindle 904 between the turntable 903 and the bearing 905, comprising an outer race 12, a hub 11, a center axle hole 111 axially extended through the center of the hub 11 and mounted on the spindle 904 of the motor 9, an open chamber 13 defined around the periphery of the hub 11 within the outer race 12, an inner race 14 suspended in the open chamber 13 and concentrically arranged between the outer race 12 and the hub 11, an inner annular track 16 defined around the periphery of the hub 11 within the inner race 14, and an outer annular track 15 defined around the periphery of the inner race 14 within the outer race 12.

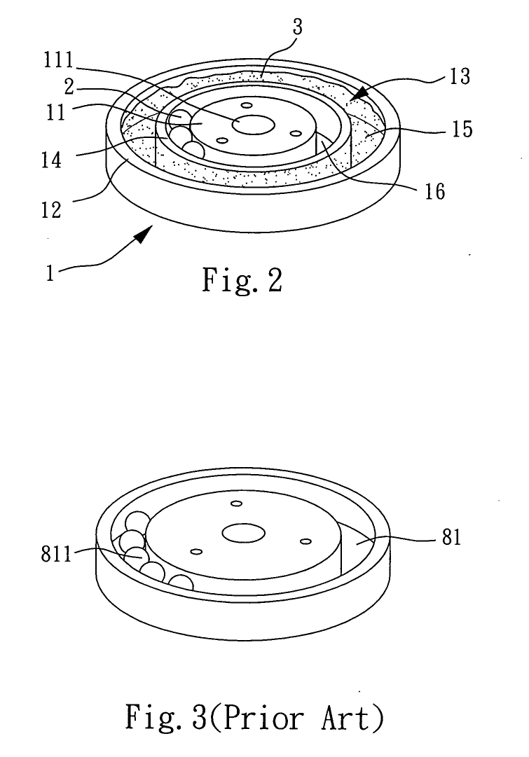

Referring to FIG. 2, three rolling balls 2, in this embodiment are steel balls, are received in the inner annular track 16, and a balancing fluid 3 is filled in the outer annular track 15. The balancing fluid 3 is a fluid of high viscosity. Preferably, the balancing fluid 3 is oil. Cream, glycerin, or lubricant may be used for the balancing fluid 3. The oil seal 4 seals the balancing fluid 3 in the auto-balancing device 1, preventing a leakage. When the motor 9 started to rotate after the loading of a compact disk on the turntable 903, the balancing force of the combination design of the rolling balls 2 and the balancing fluid 3 balances eccentric mass and prohibits the production of vibrations and noises upon rotary motion of the motor 9.

Although the present invention has been explained in relation to its preferred embodiment, it is to be understood that many other possible modifications and variations can be made without departing from the spirit and scope of the invention as hereinafter claimed.

What is claimed is:

1. An auto-balancing device mounted on a spindle of a motor of a disk player, said auto-balancing device comprising:
a device shell, said device shell comprising an outer race, a hub, a center axle hole axially extended through the center of said hub and mounted on the spindle of said motor, an open chamber defined around the periphery of said hub within said outer race, an inner race suspended in said open chamber and concentrically arranged between said outer race and said hub, an inner annular track defined around the periphery of said hub within said inner race, and an outer annular track defined around the periphery of said inner race within said outer race,
a plurality of rolling balls moving in said inner annular track; and
a balancing fluid filled in said outer annular track.

2. The auto-balancing device as claimed in claim 1, further comprising an oil seal fastened to said device shell to seal said balancing fluid in said outer annular track.

3. The auto-balancing device as claimed in claim 1, wherein said balancing fluid is a fluid having a high viscosity.

4. The auto-balancing device as claimed in claim 3, wherein said balancing fluid having a high viscosity is oil.
